(19) United States
(12) Patent Application Publication
(10) Pub. No.: US 2021/0090497 A1
(43) Pub. Date: Mar. 25, 2021

(54) DISPLAY PANEL DRIVING METHOD

(71) Applicant: Raydium Semiconductor Corporation, Hsinchu (TW)

(72) Inventors: SHANG-PING TANG, Hsinchu City (TW); HUNG LI, Taipei City (TW)

(21) Appl. No.: 17/027,850

(22) Filed: Sep. 22, 2020

Related U.S. Application Data
(60) Provisional application No. 62/905,573, filed on Sep. 25, 2019.

(51) Int. Cl. G09G 3/3225

(52) U.S. Cl. CPC G09G 3/3225; G09G 2300/0465

(57) ABSTRACT

A display panel driving method is used to drive a display panel including a first display area having a first pixel density and a second display area having a second pixel density. The first pixel density is larger than the second pixel density. There are regular linear boundaries connected to each other between the first display area and the second display area. Each regular linear boundary includes at least one vertical segment and/or at least one horizontal segment having a length larger than or equal to that of adjacent pixels in the first display area. The display panel driving method includes steps of: (a) at the regular linear boundaries, driving pixels in alternate rows and/or alternate columns to display along vertical direction and/or horizontal direction; and (b) in the second display area, driving pixels in alternate rows and/or alternate columns to display along vertical direction and/or horizontal direction.

### BACKGROUND OF THE INVENTION

### 1. Field of the Invention

The invention relates to display panel; in particular, to a display panel driving method.

### 2. Description of the Prior Art

Please refer to FIG. 1, when the conventional display panel 1 includes a first display area DA1 and a second display area DA2 and the first display area DA1 and the second display area DA2 have different pixel densities, the boundary B between the first display area DA1 and the second display areas DA2 mostly adopts an arc design and some pixels PX arranged closely are distributed on the boundary B.

However, because these pixels PX distributed on the arc edge of the boundary B cross the first display area DA1 and the second display area DA2 with different pixel densities at the same time, and often have independent color points that are difficult to handle, resulting in that human eyes can easily perceive the existence of the boundary B when viewing the conventional display panel 1. In addition, because the first display area DA1 and the second display area DA2 have different pixel densities, but some of the pixels of the two are arranged closely without interval, it is easy to interfere with each other to cause errors during display data calculation.

Therefore, the above-mentioned problems encountered by the prior art need to be further solved.

### SUMMARY OF THE INVENTION

Therefore, the invention provides a display panel driving method to solve the above-mentioned problems occurred in the prior arts.

An embodiment of the invention is a display panel driving method. In this embodiment, the display panel driving method is used to drive a display panel including a first display area having a first pixel density and a second display area having a second pixel density. The first pixel density is larger than the second pixel density. There are regular linear boundaries connected to each other between the first display area and the second display area. Each regular linear boundary includes at least one vertical segment and/or at least one horizontal segment having a length larger than or equal to that of adjacent pixels in the first display area. The display panel driving method includes steps of: (a) at the regular linear boundaries, driving pixels in alternate rows and/or alternate columns to display along vertical direction and/or horizontal direction; and (b) in the second display area, driving pixels in alternate rows and/or alternate columns to display along vertical direction and/or horizontal direction.

In an embodiment, driving pixels in alternate rows and/or alternate columns to display in the step (a) and the step (b) is to drive pixels with at least an interval of one row of pixels and/or a column of pixels in the first display area.

In an embodiment, the regular linear boundaries include a first regular linear boundary and a second regular linear boundary connected to each other.

In an embodiment, the first regular linear boundary and the second regular linear boundary are straight lines perpendicular to each other.

In an embodiment, the regular linear boundaries further include a third regular linear boundary connected to the second regular linear boundary.

In an embodiment, the third regular linear boundary is a straight line perpendicular to the second regular linear boundary.

In an embodiment, the third regular linear boundary is a polyline; a segment of the third regular linear boundary and the second regular linear boundary are connected and perpendicular to each other.

In an embodiment, the first regular linear boundary is a straight line and the second regular linear boundary is a polyline; a segment of the second regular linear boundary and the first regular linear boundary are connected and perpendicular to each other.

In an embodiment, the regular linear boundaries further include a third regular linear boundary connected to the second regular linear boundary.

In an embodiment, the third regular linear boundary is a straight line perpendicular to another segment of the second regular linear boundary.

In an embodiment, the third regular linear boundary is a polyline; a segment of the third regular linear boundary and another segment of the second regular linear boundary are connected and perpendicular to each other.

In an embodiment, the first regular linear boundary and the second regular linear boundary are both polylines, a first segment of the first regular linear boundary and a second segment of the second regular linear boundary are connected and perpendicular to each other.

In an embodiment, the regular linear boundaries further include a third regular linear boundary connected to the second regular linear boundary.

In an embodiment, the third regular linear boundary is a straight line perpendicular to another segment of the second regular linear boundary.

In an embodiment, the third regular linear boundary is a polyline; a segment of the third regular linear boundary and another segment of the second regular linear boundary are connected and perpendicular to each other.

In an embodiment, the second display area has a shape of a polygon.

In an embodiment, the polygon is formed by at least one rectangle.

In an embodiment, the polygon is symmetrical.

In an embodiment, the polygon is unsymmetrical.

In an embodiment, the display panel is an organic light-emitting diode (OLED) display panel.

Compared to the prior arts, when the different display areas of the display panel have different pixel densities, the display panel driving method according to the present invention adopts a regular straight-line border instead of the traditional arc edge design, and passes at the border and in the display area with lower pixel density. The interlaced and/or interlaced driving pixel display method effectively avoids the problem of color dots, color shift, and uneven brightness caused by the traditional display panel at the junction of two display areas with different pixel densities, which may cause the two display areas to not be visually integrated. It greatly enhances the visual experience of the human eye, and can also avoid the phenomenon of mutual interference during display data calculation.

The advantage and spirit of the invention may be understood by the following detailed descriptions together with the appended drawings.

### BRIEF DESCRIPTION OF THE APPENDED DRAWINGS

FIG. 1 illustrates a schematic diagram of a conventional display panel in which the boundary between the first display area and the second display area with different pixel densities adopts an arc design.

FIG. 2 illustrates a flowchart of the display panel driving method in a preferred embodiment of the invention.

FIG. 3A to FIG. 3E illustrate different embodiments in which the shape of the second display area is a polygon formed by one or more rectangles respectively.

FIG. 4A to FIG. 4C illustrate different embodiments of the first regular linear boundary and the second regular linear boundary between the first display area and the second display area respectively.

FIG. 5A to FIG. 5F illustrate different embodiments of the first regular linear boundary to the third regular linear boundary between the first display area and the second display area respectively.

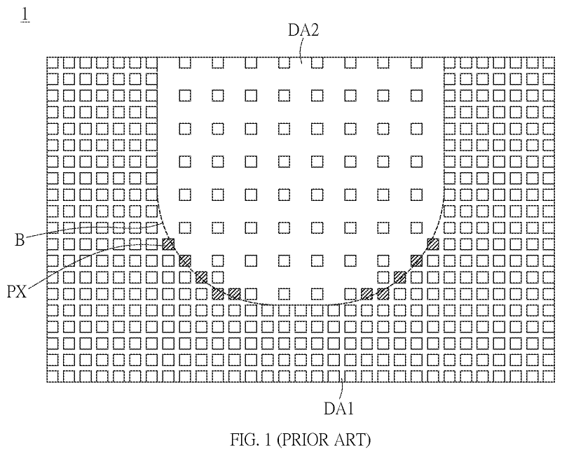

### DETAILED DESCRIPTION OF THE INVENTION

Reference will now be made in detail to the exemplary embodiments, the same or similar reference numbers or components used in the drawings and the embodiments are used to represent the same or similar parts.

An embodiment of the invention is a display panel driving method. In this embodiment, the display panel driving method is used to drive a display panel. The display panel at least includes a first display area and a second display area. The first display area has a first pixel density and the second display area has a second pixel density. The first pixel density is greater than the second pixel density.

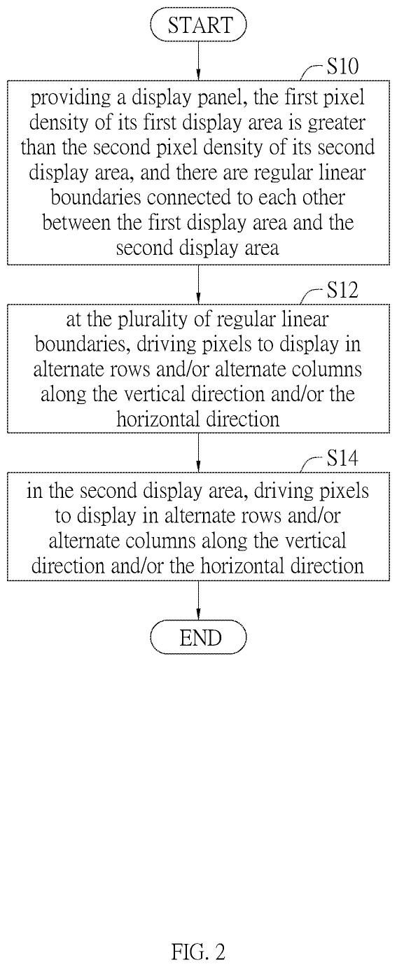

Please refer to FIG. 2. FIG. 2 shows a flowchart of the display panel driving method in this embodiment. As shown in FIG. 2, the display panel driving method can include the following steps S10 to S14:

Step S10: providing a display panel, the first pixel density of its first display area is greater than the second pixel density of its second display area, and there is a plurality of regular linear boundaries connected to each other between the first display area and the second display area, wherein each regular linear boundary includes at least one vertical line segment and/or at least one horizontal line segment, and the length of the at least one vertical line segment/the at least one horizontal line segment is greater than or equal to the length of two adjacent pixels in the first display area;

Step S12: at the plurality of regular linear boundaries, driving pixels to display in alternate rows and/or alternate columns along the vertical direction and/or the horizontal direction; and

Step S14: in the second display area, driving pixels to display in alternate rows and/or alternate columns along the vertical direction and/or the horizontal direction.

It should be noted that “driving pixels to display in alternate rows and/or alternate columns” described in the step S12 and the step 14 refers to “driving pixels with at least an interval of one row of pixels and/or a column of pixels in the first display area with a higher pixel density”, so as to avoid driving pixels to display on the regular linear boundaries or positions quite close to the regular linear boundaries, but not limited to this.

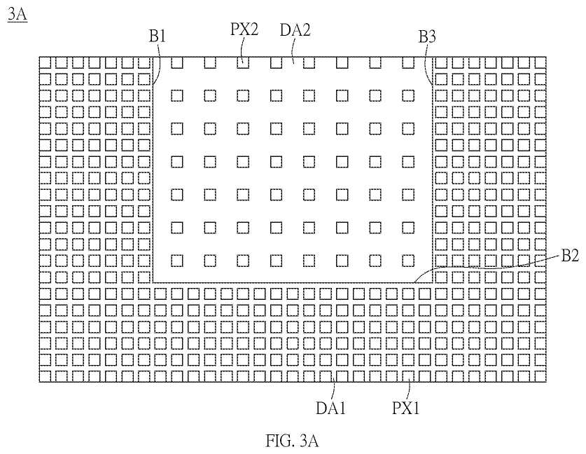

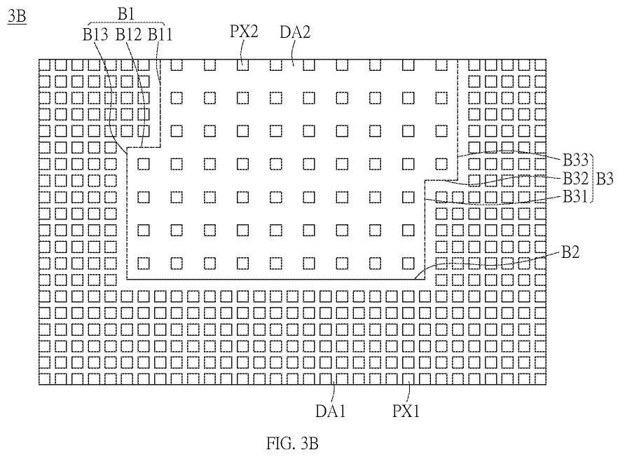

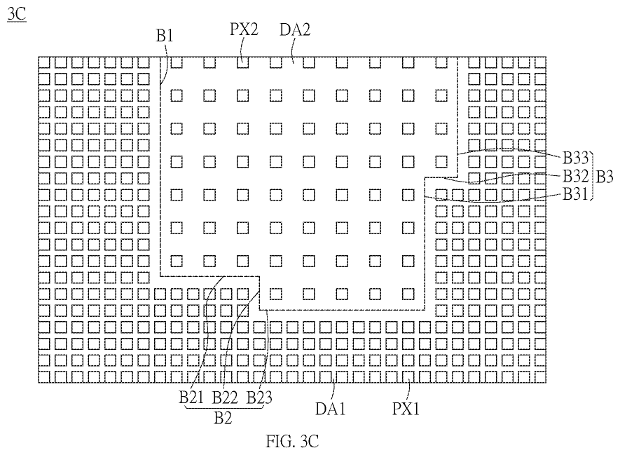

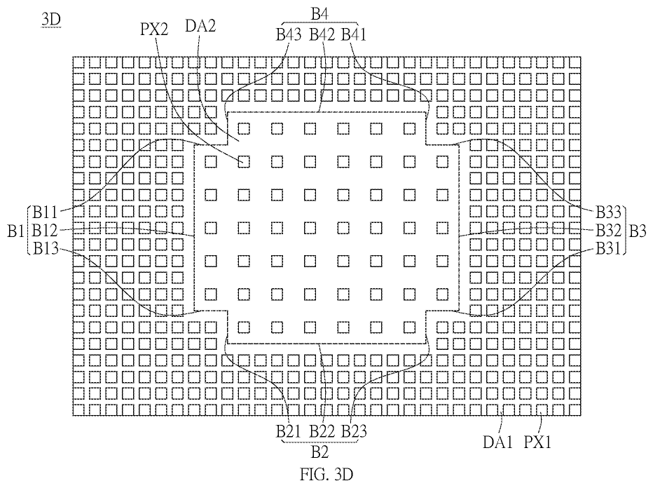

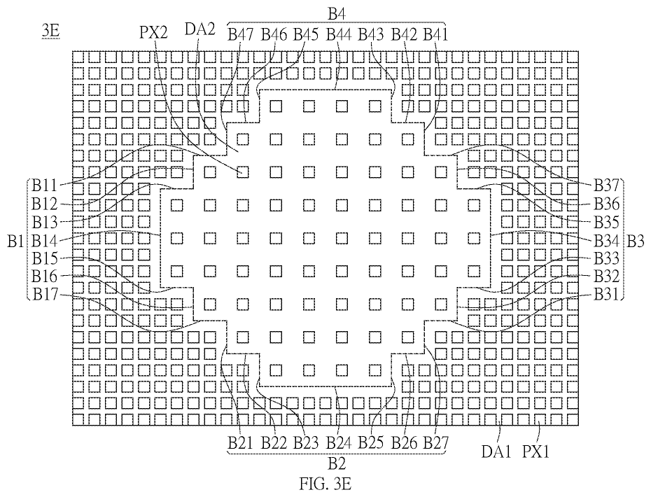

In practical applications, the shape of the second display area with lower pixel density can be a polygon formed by one or more rectangles. Please refer to FIG. 3A to FIG. 3E.

FIG. 3A to FIG. 3E illustrate different embodiments in which the shape of the second display area with lower pixel density is a polygon formed by one or more rectangles respectively.

As shown in FIG. 3A, the display panel 3A includes a first display area DA1 and a second display area DA2. The first pixel density of the first display area DA1 is greater than the second pixel density of the second display area DA2. The shape of the second display area DA2 is a rectangle. The first display area DA1 and the second display area DA2 have a first regular linear boundary B1, a second regular linear boundary B2 and a third regular linear boundary B3 connected to each other.

In this embodiment, the first regular linear boundary B1 is a vertical line segment, the second regular linear boundary B2 is a horizontal line segment, and the third regular linear boundary B3 is a vertical line segment. The lengths of the first regular linear boundary B1, the second regular linear boundary B2 and the third regular linear boundary B3 are all greater than or equal to the length of two adjacent pixels PX1 in the first display area DA1, but not limited to this.

It should be noted that, at the first regular linear boundary B1, the second regular linear boundary B2, the third regular linear boundary B3 and in the second display area DA2, the display panel driving method of the invention drives the pixels to display in alternate rows and alternate columns along the vertical direction and the horizontal direction. In other words, at the first regular linear boundary B1, the second regular linear boundary B2, the third regular linear boundary B3 and in the second display area DA2, the pixels should be driven to display with at least an interval of one row and one column of pixels PX1 of the first display area DA1 with higher pixel density to avoid the disadvantages of the prior art.

As shown in FIG. 3B, the display panel 3B includes a first display area DA1 and a second display area DA2. The first pixel density of the first display area DA1 is greater than the second pixel density of the second display area DA2. The shape of the second display area DA2 is a polygon formed by two rectangles. There are a first regular linear boundary B1, a second regular linear boundary B2 and a third regular linear boundary B3 connected to each other between the first display area DA1 and the second display area DA2.

In this embodiment, the first regular linear boundary B1 is a polyline including a vertical line segment B11, a horizontal line segment B12 and a vertical line segment B13 connected to each other; the second regular linear boundary B2 is a horizontal line segment; the third regular linear boundary B3 is a polyline including a vertical line segment B31, a horizontal line segment B32 and a vertical line segment B33 connected to each other. The lengths of the first regular linear boundary B1, the second regular linear boundary B2 and the third regular linear boundary B3 are all greater than or equal to the length of two adjacent pixels PX1 in the first display area DA1, but not limited to this.

It should be noted that at the first regular linear boundary B1, the second regular linear boundary B2, the third regular linear boundary B3 and in the second display area DA2, the display panel driving method of the invention drives the pixels to display in alternate rows and alternate columns along the vertical direction and the horizontal direction. In other words, at the first regular linear boundary B1, the second regular linear boundary B2, the third regular linear boundary B3 and in the second display area DA2, the pixels should be driven to display with at least an interval of one row and one column of pixels PX1 of the first display area DA1 with higher pixel density to avoid the disadvantages of the prior art.

As shown in FIG. 3C, the display panel 3C includes a first display area DA1 and a second display area DA2. The first pixel density of the first display area DA1 is greater than the second pixel density of the second display area DA2. The shape of the second display area DA2 is a polygon formed by three rectangles. There are a first regular linear boundary B1, a second regular linear boundary B2 and a third regular linear boundary B3 connected to each other between the first display area DA1 and the second display area DA2.

In this embodiment, the first regular linear boundary B1 is a vertical line segment; the second regular linear boundary B2 is a polyline including a horizontal line segment B21, a vertical line segment B22 and a horizontal line segment B23 connected to each other; the third regular linear boundary B3 is a polyline including a vertical line segment B31, a horizontal line segment B32 and a vertical line segment B33 connected to each other. The lengths of the first regular linear boundary B1, the second regular linear boundary B2 and the third regular linear boundary B3 are all greater than or equal to the length of two adjacent pixels PX1 in the first display area DA1, but not limited to this.

It should be noted that at the first regular linear boundary B1, the second regular linear boundary B2, the third regular linear boundary B3 and in the second display area DA2, the display panel driving method of the invention drives the pixels to display in alternate rows and alternate columns along the vertical direction and the horizontal direction. In other words, at the first regular linear boundary B1, the second regular linear boundary B2, the third regular linear boundary B3 and in the second display area DA2, the pixels should be driven to display with at least an interval of one row and one column of pixels PX1 of the first display area DA1 with higher pixel density to avoid the disadvantages of the prior art.

As shown in FIG. 3D, the display panel 3D includes a first display area DA1 and a second display area DA2. The first pixel density of the first display area DA1 is greater than the second pixel density of the second display area DA2. The shape of the second display area DA2 is a polygon formed by two rectangles. There are a first regular linear boundary B1, a second regular linear boundary B2, a third regular linear boundary B3 and a fourth regular linear boundary B4 connected to each other between the first display area DA1 and the second display area DA2.

In this embodiment, the first regular linear boundary B1 is a polyline including a horizontal line segment B11, a vertical line segment B12 and a horizontal line segment B13 connected to each other; the second regular linear boundary B2 is a polyline including a vertical line segment B21, a horizontal line segment B22 and a vertical line segment B23 connected to each other; the third regular linear boundary B3 is a polyline including a horizontal line segment B31, a vertical line segment B32 and a horizontal line segment B33 connected to each other; the fourth regular linear boundary B4 is a polyline including a vertical line segment B41, a horizontal line segment B42 and a vertical line segment B43 connected to each other. The lengths of the first regular linear boundary B1, the second regular linear boundary B2, the third regular linear boundary B3, and the fourth regular linear boundary B4 are all greater than or equal to the length of two adjacent pixels PX1 in the first display area DA1, but not limited to this.

It should be noted that at the first regular linear boundary B1, the second regular linear boundary B2, the third regular linear boundary B3, the fourth regular linear boundary B4 and in the second display area DA2, the display panel driving method of the invention is to drive pixel display in alternate rows and columns along the vertical and horizontal directions. In other words, at the first regular linear boundary B1, the second regular linear boundary B2, the third regular linear boundary B3, the fourth regular linear boundary B4 and in the second display area DA2, the pixels should be driven to display with at least an interval of one row and one column of pixels PX1 of the first display area DA1 with higher pixel density to avoid the disadvantages of the prior art.

As shown in FIG. 3E, the display panel 3E includes a first display area DA1 and a second display area DA2. The first pixel density of the first display area DA1 is greater than the second pixel density of the second display area DA2. The shape of the second display area DA2 is a polygon formed by four rectangles. There are a first regular linear boundary B1, a second regular linear boundary B2, a third regular linear boundary B3 and a fourth regular linear boundary B4 connected to each other between the first display area DA1 and the second display area DA2.

In this embodiment, the first regular linear boundary B1 is a polyline including a horizontal line segment B11, a vertical line segment B12, a horizontal line segment B13, a vertical line segment B14, a horizontal line segment B15, a vertical line segment B16 and a horizontal line segment B17 that are connected to each other; the second regular linear boundary B2 is a polyline including a vertical line segment B21, a horizontal line segment B22, a vertical line segment B23, a horizontal line segment B24, a vertical line segment B25, a horizontal line segment B26 and a vertical line segment B27 connected to each other; the third regular linear boundary B3 is a polyline including a horizontal line segment B31, a vertical line segment B32, a horizontal line segment B33, a vertical line segment B34, a horizontal line segment B35, a vertical line segment B36 and a horizontal line segment B37 connected to each other; the fourth regular linear boundary B4 is a polyline including a vertical line segment B41, a horizontal line segment B42, a vertical line segment B43, a horizontal line segment B44, a vertical line segment B45, a horizontal line segment B46 and a vertical line segment B47 connected to each other. The lengths of the first regular linear boundary B1, the second regular linear boundary B2, the third regular linear boundary B3 and the fourth regular linear boundary B4 are all greater than or equal to the length of two adjacent pixels PX1 in the first display area DA1, but not limited to this.

It should be noted that at the first regular linear boundary B1, the second regular linear boundary B2, the third regular linear boundary B3, the fourth regular linear boundary B4 and in the second display area DA2, the display panel driving method of the invention is to drive pixel display in alternate rows and columns along the vertical and horizontal directions. In other words, at the first regular linear boundary B1, the second regular linear boundary B2, the third regular linear boundary B3, the fourth regular linear boundary B4 and in the second display area DA2, the pixels should be driven to display with at least an interval of one row and one column of pixels PX1 of the first display area DA1 with higher pixel density to avoid the disadvantages of the prior art.

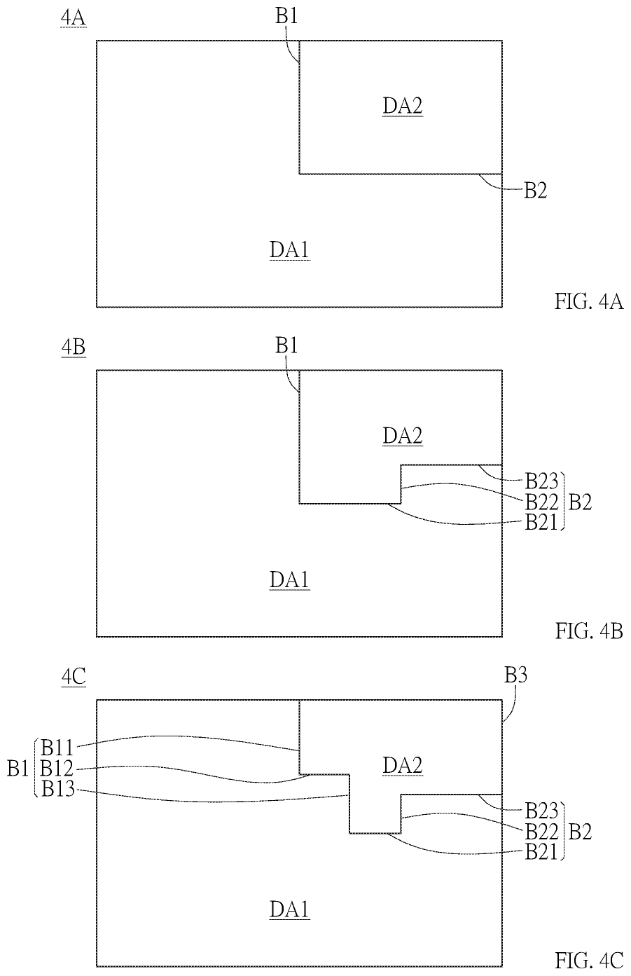

Next, please refer to FIG. 4A to FIG. 4C. FIG. 4A to FIG. 4C illustrate different embodiments of the first regular linear boundary B1 and the second regular linear boundary B2 between the first display area DA1 and the second display area DA2 respectively.

As shown in FIG. 4A, the display panel 4A includes a first display area DA1 and a second display area DA2. The first pixel density of the first display area DA1 is greater than the second pixel density of the second display area DA2. The shape of the second display area DA2 is rectangular. A first regular linear boundary B1 and a second regular linear boundary B2 are connected between the first display area DA1 and the second display area DA2. The first regular linear boundary B1 is a vertical line segment and the second regular linear boundary B2 is a horizontal line segment.

As shown in FIG. 4B, the display panel 4B includes a first display area DA1 and a second display area DA2. The first pixel density of the first display area DA1 is greater than the second pixel density of the second display area DA2. The shape of the second display area DA2 is a polygon formed by two rectangles. A first regular linear boundary B1 and a second regular linear boundary B2 are connected between the first display area DA1 and the second display area DA2. The first regular linear boundary B1 is a vertical line segment and the second regular linear boundary B2 is a polyline including a horizontal line segment B21, a vertical line segment B22 and a horizontal line segment B23 connected to each other.

As shown in FIG. 4C, the display panel 4C includes a first display area DA1 and a second display area DA2. The first pixel density of the first display area DA1 is greater than the second pixel density of the second display area DA2. The shape of the second display area DA2 is a polygon formed by three rectangles. A first regular linear boundary B1 and a second regular linear boundary B2 are connected between the first display area DA1 and the second display area DA2. The first regular linear boundary B1 is a polyline including a vertical line segment B11, a horizontal line segment B12 and a vertical line segment B13 connected to each other, and the second regular linear boundary B2 is a polyline including a horizontal line segment B21, a vertical line segment B22 and a horizontal line segment B23 connected to each other.

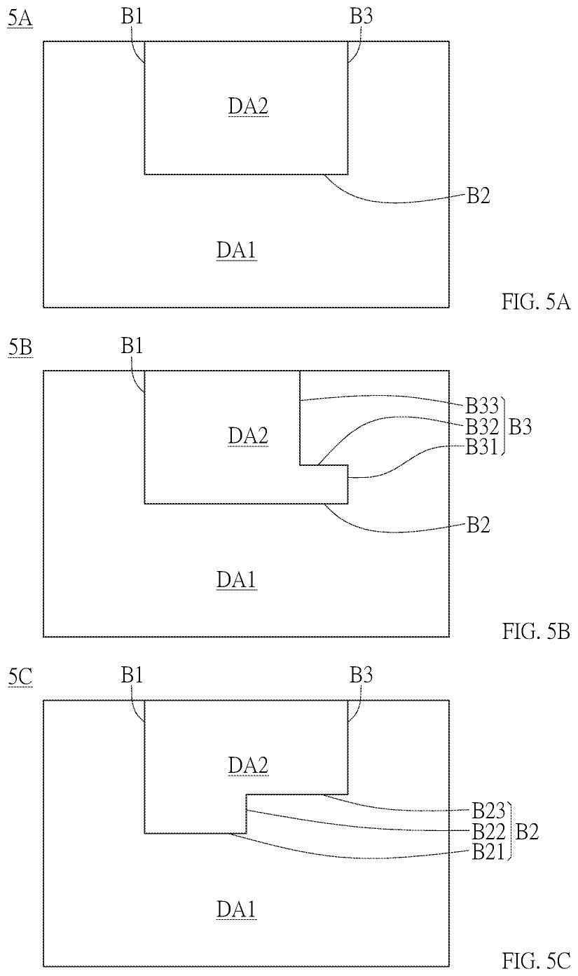

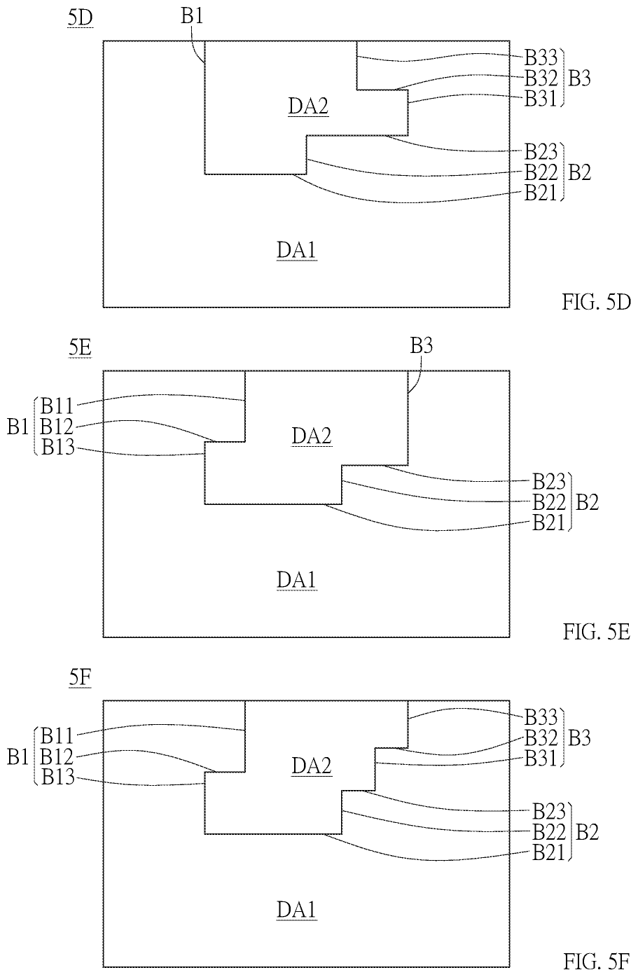

Next, please refer to FIG. 5A to FIG. 5F. FIG. 5A to FIG. 5F illustrate different embodiments of the first regular linear boundary B1 to the third regular linear boundary B3 between the first display area DA1 and the second display area DA2 respectively.

As shown in FIG. 5A, the display panel 5A includes a first display area DA1 and a second display area DA2. The first pixel density of the first display area DA1 is greater than the second pixel density of the second display area DA2. The shape of the second display area DA2 is rectangular. There are a first regular linear boundary B1, a second regular linear boundary B2 and a third regular linear boundary B3 connected to each other between the first display area DA1 and the second display area DA2. The first regular linear boundary B1 is a vertical line segment, the second regular linear boundary B2 is a horizontal line segment, and the third regular linear boundary B3 is a vertical line segment.

As shown in FIG. 5B, the display panel 5B includes a first display area DA1 and a second display area DA2. The first pixel density of the first display area DA1 is greater than the second pixel density of the second display area DA2. The shape of the second display area DA2 is a polygon formed by two rectangles. There are a first regular linear boundary B1, a second regular linear boundary B2 and a third regular linear boundary B3 connected to each other between the first display area DA1 and the second display area DA2. The first regular linear boundary B1 is a vertical line segment, the second regular linear boundary B2 is a horizontal line segment and the third regular linear boundary B3 is a polyline including a vertical line segment B31, a horizontal line segment B32 and a vertical line segment B33 connected to each other.

As shown in FIG. 5C, the display panel 5C includes a first display area DA1 and a second display area DA2. The first pixel density of the first display area DA1 is greater than the second pixel density of the second display area DA2. The shape of the second display area DA2 is a polygon formed by two rectangles. The first display area DA1 and the second display area DA2 have a first regular linear boundary B1, a second regular linear boundary B2, and a third regular linear boundary B3 connected to each other. The first regular linear boundary B1 is a vertical line segment, the second regular linear boundary B2 is a polyline including a horizontal line segment B21, a vertical line segment B22 and a horizontal line segment B23 connected to each other and the third regular linear boundary B3 is a vertical line segment.

As shown in FIG. 5D, the display panel 5D includes a first display area DA1 and a second display area DA2. The first pixel density of the first display area DA1 is greater than the second pixel density of the second display area DA2. The shape of the second display area DA2 is a polygon formed by three rectangles. There are a first regular linear boundary B1, a second regular linear boundary B2 and a third regular linear boundary B3 connected to each other between the first display area DA1 and the second display area DA2. The first regular linear boundary B1 is a vertical line segment, the second regular linear boundary B2 is a polyline including a horizontal line segment B21, a vertical line segment B22 and a horizontal line segment B23 connected to each other, and the third regular linear boundary B3 is a polyline including a vertical line segment B31, a horizontal line segment B32 and a vertical line segment B33 connected to each other.

As shown in FIG. 5E, the display panel 5E includes a first display area DA1 and a second display area DA2. The first pixel density of the first display area DA1 is greater than the second pixel density of the second display area DA2. The shape of the second display area DA2 is a polygon formed by two rectangles. There are a first regular linear boundary B1, a second regular linear boundary B2 and a third regular linear boundary B3 connected to each other between the first display area DA1 and the second display area DA2. The first regular linear boundary B1 is a polyline including a vertical line segment B11, a horizontal line segment B12 and a vertical line segment B13 connected to each other, and the second regular linear boundary B2 is a polyline including a horizontal line segment B21, a vertical line segment B22 and a horizontal line segment B23 connected to each other and the third regular linear boundary B3 is a vertical line segment.

As shown in FIG. 5F, the display panel 5F includes a first display area DA1 and a second display area DA2. The first pixel density of the first display area DA1 is greater than the second pixel density of the second display area DA2. The shape of the second display area DA2 is a polygon formed by three rectangles. There are a first regular linear boundary B1, a second regular linear boundary B2 and a third regular linear boundary B3 connected to each other between the first display area DA1 and the second display area DA2. The first regular linear boundary B1 is a polyline including a vertical line segment B11, a horizontal line segment B12 and a vertical line segment B13 connected to each other, and the second regular linear boundary B2 is a polyline including a horizontal line segment B21, a vertical line segment B22 and a horizontal line segment B23 connected to each other and the third regular linear boundary B3 is a polyline including a vertical line segment B31, a horizontal line segment B32 and a vertical line segment B33 connected to each other.

As for the different embodiments with the first regular linear boundary B1 to the fourth regular linear boundary B4 between the first display area DA1 and the second display area DA2, please refer to FIG. 3D to FIG. 3E and so on. It will be not repeated here.

Compared to the prior arts, when the different display areas of the display panel have different pixel densities, the display panel driving method according to the present invention adopts a regular straight-line border instead of the traditional arc edge design, and passes at the border and in the display area with lower pixel density. The interlaced and/or interlaced driving pixel display method effectively avoids the problem of color dots, color shift, and uneven brightness caused by the traditional display panel at the junction of two display areas with different pixel densities, which may cause the two display areas to not be visually integrated. It greatly enhances the visual experience of the human eye, and can also avoid the phenomenon of mutual interference during display data calculation.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A display panel driving method, applied to drive a display panel comprising a first display area having a first pixel density and a second display area having a second pixel density, the first pixel density being larger than the second pixel density, there being regular linear boundaries connected to each other between the first display area and the second display area; each of the regular linear boundaries comprising at least one vertical segment and/or at least one horizontal segment having a length larger than or equal to that of two adjacent pixels in the first display area, the display panel driving method comprising steps of:
(a) at the regular linear boundaries, driving pixels in alternate rows and/or alternate columns to display along a vertical direction and/or a horizontal direction; and
(b) in the second display area, driving pixels in alternate rows and/or alternate columns to display along the vertical direction and/or the horizontal direction.

2. The display panel driving method of claim 1, wherein driving pixels in alternate rows and/or alternate columns to display in the step (a) and the step (b) is to drive pixels with at least an interval of one row of pixels and/or a column of pixels in the first display area.

3. The display panel driving method of claim 1, wherein the regular linear boundaries comprise a first regular linear boundary and a second regular linear boundary connected to each other.

4. The display panel driving method of claim 3, wherein the first regular linear boundary and the second regular linear boundary are straight lines perpendicular to each other.

5. The display panel driving method of claim 4, wherein the regular linear boundaries further comprise a third regular linear boundary connected to the second regular linear boundary.

6. The display panel driving method of claim 5, wherein the third regular linear boundary is a straight line perpendicular to the second regular linear boundary.

7. The display panel driving method of claim 5, wherein the third regular linear boundary is a polyline; a segment of the third regular linear boundary and the second regular linear boundary are connected and perpendicular to each other.

8. The display panel driving method of claim 3, wherein the first regular linear boundary is a straight line and the second regular linear boundary is a polyline; a segment of the second regular linear boundary and the first regular linear boundary are connected and perpendicular to each other.

9. The display panel driving method of claim 8, wherein the regular linear boundaries further comprise a third regular linear boundary connected to the second regular linear boundary.

10. The display panel driving method of claim 9, wherein the third regular linear boundary is a straight line perpendicular to another segment of the second regular linear boundary.

11. The display panel driving method of claim 9, wherein the third regular linear boundary is a polyline; a segment of the third regular linear boundary and another segment of the second regular linear boundary are connected and perpendicular to each other.

12. The display panel driving method of claim 3, wherein the first regular linear boundary and the second regular linear boundary are both polylines, a first segment of the first regular linear boundary and a second segment of the second regular linear boundary are connected and perpendicular to each other.

13. The display panel driving method of claim 12, wherein the regular linear boundaries further comprise a third regular linear boundary connected to the second regular linear boundary.

14. The display panel driving method of claim 13, wherein the third regular linear boundary is a straight line perpendicular to another segment of the second regular linear boundary.

15. The display panel driving method of claim 13, wherein the third regular linear boundary is a polyline; a segment of the third regular linear boundary and another segment of the second regular linear boundary are connected and perpendicular to each other.

16. The display panel driving method of claim 1, wherein the second display area has a shape of a polygon.

17. The display panel driving method of claim 16, wherein the polygon is formed by at least one rectangle.

18. The display panel driving method of claim 16, wherein the polygon is symmetrical.

19. The display panel driving method of claim 16, wherein the polygon is unsymmetrical.

20. The display panel driving method of claim 1, wherein the display panel is an organic light-emitting diode (OLED) display panel.
